(19) United States
(12) Patent Application Publication
(10) Pub. No.: US 2026/0202852 A1
(43) Pub. Date: Jul. 16, 2026

(54) SERVICE ROBOT RECOVERY FROM A BLOCKED PATH

(71) Applicant: Bear Robotics, Inc., Redwood City, CA (US)

(72) Inventor: Konstantin Stulov, Redwood City, CA (US)

(21) Appl. No.: 19/134,926

(22) PCT Filed: Dec. 1, 2023
(86) PCT No.: PCT/US2023/082075

§ 371 Date: Jun. 2, 2025

Related U.S. Application Data
(60) Provisional application No. 63/385,856, filed on Dec. 2, 2022.

(51) Int. Cl. G05D 1/639; G05D 1/24; G05D 1/689; G05D 105/70; G05D 109/10; G05D 111/10; G05D 111/50

(52) U.S. Cl. CPC G05D 1/642; G05D 1/24; G05D 1/689; G05D 2105/70; G05D 2109/10; G05D 2111/17; G05D 2111/52

(57) ABSTRACT

A computer-implemented method and apparatus for recovering travel of a service robot. The method includes detecting a first obstacle in a first path to a destination of the service robot, performing an orientation operation to align a camera of the service robot with the first obstacle, capturing an image of the first obstacle, processing the image to identify an obstacle type of the first obstacle, and based on an identification of the first obstacle as a person obstacle type, generating a communication requesting assistance.

### CLAIM FOR PRIORITY

This application claims the benefit of the filing date of U.S. patent application Ser. No. 63/385,856 filed on Dec. 2, 2022, the disclosure of which is hereby incorporated by reference in its entirety.

### TECHNICAL FIELD

The disclosed subject matter relates generally to the technical field of mobile robots and delivery systems and, in one specific example, to a solution for travel recovery from a blocked path for a mobile robot.

### BACKGROUND

Mobile service robots operate in many environments, from commercial and hospitality settings (such as stores, restaurants and hotels) to healthcare facilities, warehouses and conference centers. Service robots perform a wide variety of tasks, including food and supply delivery, sanitation tasks and customer service functions such as concierge services or automated valet parking. To accomplish their tasks in a timely fashion, mobile service robots must efficiently navigate environments with potentially complicated layouts, in the presence of both static obstacles such as walls or stairs, and dynamic obstacles, such as people, tables or chairs.

Such navigation solutions can be fully autonomous or involve robot-human communications.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a perspective view of a service robot, according to some examples, that can be deployed within a location.

FIG. 2 is a block diagram illustrating a view of components and modules of a service robot, according to some examples.

FIG. 3 is a block diagram illustrating a view of components and modules of a service robot, according to some examples.

FIG. 4 is a block diagram illustrating a view of components and modules of a service robot, according to some examples.

FIG. 5 is a block diagram illustrating a view of components and modules of a service robot, according to some examples.

FIG. 6 is a flowchart showing a view of a travel recovery method, according to some examples, as performed by modules and components of the service robot.

FIG. 7 is a diagrammatic depiction of a portion of travel recovery for a service robot, according to some examples.

FIG. 8 is a diagrammatic depiction of a portion of an example travel recovery for a service robot, according to some examples.

FIG. 9 is a diagrammatic depiction of a portion of travel recovery for a service robot, according to some examples.

FIG. 10 is a flowchart showing a view of a robot orientation method, according to some examples, as performed by modules and components of the service robot.

FIG. 11 is a flowchart showing a view of a robot orientation method, according to some examples, as performed by modules and components of the service robot.

FIG. 12 is a flowchart showing a view of an obstacle location seeking method, according to some examples, as performed by modules and components of the service robot.

FIG. 13 is a flowchart showing a view of an obstacle location seeking method, according to some examples, as performed by modules and components of the service robot.

FIG. 14 is an illustration, according to some examples, of an obstacle location seeking method, according to some examples, as performed by modules and components of the service robot.

FIG. 15 is a diagrammatic depiction of an example of travel recovery module behavior for a service robot, according to some examples.

FIG. 16 is a flowchart showing a view of a method, according to some examples, such as the one in FIG. 15.

FIG. 17 is a flowchart showing a view of a method related to some examples, such as the one in FIG. 15.

FIG. 18 is a flowchart illustrating an additional method implemented by a travel recovery module, according to some examples.

FIG. 19 is a block diagram showing a model system, according to some examples, that operates to create and maintain image localization models that are deployed at various service robots at one or more locations.

FIG. 20 is a block diagram showing a software architecture within which the present disclosure may be implemented, according to some examples.

FIG. 21 is a diagrammatic representation of a machine in the form of a computer system within which a set of instructions may be executed for causing the machine to perform any one or more of the methodologies discussed herein, in accordance with some examples.

FIG. 22 is a diagrammatic representation of a processing environment, in accordance with some examples.

FIG. 23 is a diagrammatic representation of an environment in which multiple service robots are deployed to respective locations or environments, such as restaurants, hospitals, or senior care facilities.

### DETAILED DESCRIPTION

Mobile service robots operate in many environments, from commercial and hospitality settings to healthcare facilities, warehouses and conference centers. Service robots perform tasks such as food and supply delivery, sanitation tasks, customer service tasks including concierge services or automated valet parking. In order to accomplish their tasks in a timely fashion, mobile service robots must efficiently navigate environments with potentially complicated layouts, in the presence of both static obstacles such as walls or stairs, and dynamic obstacles, such as people, tables or chairs. Such navigation solutions can be fully autonomous or involve robot-human communications.

Examples in the disclosure herein refer to a method and apparatus for recovering travel of a service robot. An example method detects a first obstacle in a path to a destination of the service robot. The method performs an orientation operation to align a camera of the service robot with the first obstacle, capturing an image of the first obstacle. The image is processed, using for example CPU compute, to identify an obstacle type of the first obstacle. If the first obstacle is determined to be a PERSON obstacle, the method generates a communication requesting assistance. The communication can be an audible request for the first obstacle to be removed from the travel path of the service robot. Processing images captured by the service robot camera can include performing a depth estimate computation to identify a detected obstacle as a person. Obstacle detection by the service robot can be performed using a service robot LiDAR. Aligning the camera of the service robot with an obstacle can be done using a yaw angle orientation based on a current position of the service robot, and rotating the service robot into an obstacle-aligned position.

In some examples, after detecting a blocked first travel path, the service robot can start traveling on a second travel path. The first travel path can be calculated using a global cost map. The second travel path can be calculated using a local cost map. If the second travel path is found to be blocked, the service robot camera can be aligned with the first obstacle as follows: subtracting the global cost map from the local cost map is used to generate a subtracted cost map; the first obstacle is identified as the closest point in the subtracted cost map.

In some examples, the service robot can detect multiple obstacles in a travel path to its destination, and/or perform an orientation operation to align its camera with the plurality of obstacles. The service robot can capture an image including the multiple obstacles, and/or process the captured image to identify the type of one or more of the obstacles. If at least one obstacle is determined to have a PERSON type, the service robot can generate a communication requesting assistance with respect to removing the obstacle from the travel path to the destination.

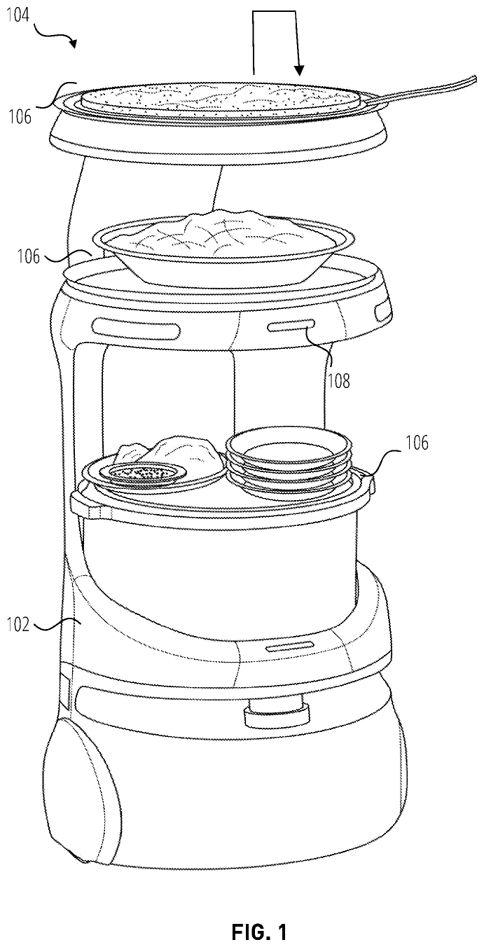

FIG. 1 is a view of a service robot 104, according to some examples, that can be deployed within a location 2302, such as a restaurant or care facility. The service robot 104 has a housing 102 that accommodates various components and modules, including a locomotion system with wheels that enable the service robot 104 to propel itself within a service location 2302. Navigation systems and perception systems are also accommodated within the housing 102. The housing 102 supports a number of trays 106 that can support and carry plates and other dishes that are delivered to and from a kitchen within a location 2302 to tables.

The service robot 104 includes multiple sensors, including exteroceptive sensors, for capturing information regarding an environment or location within which a service robot 104 may be operating, and proprioceptive sensors for capturing information related to the service robot 104 itself. Examples of exteroceptive sensors include vision sensors (e.g., two-dimensional (2D), three-dimensional (3D), depth and RGB cameras), light sensors, sound sensors (e.g., microphones or ultrasonic sensors), proximity sensors (e.g., infrared (IR) transceiver, ultrasound sensor, photoresistor), tactile sensors, temperature sensors, navigation and positioning sensors (e.g., Global Positioning System (GPS) sensor). Visual odometry and visual-SLAM (simultaneous localization and mapping) can assist a service robot 104 navigate in both indoor and outdoor environments where lighting conditions are reasonable and can be maintained. The 3D cameras, depth, and stereo vision cameras provide pose (e.g., position and orientation) information.

The service robot 104 can have a limited number (e.g., 1-4) of cameras, including a single, front-facing camera (e.g., robot camera 108).

This setup ensures that the quantity of image data captured and to be processed is manageable, and that the image processing can be done efficiently and even entirely locally (e.g., using CPU compute). In some examples, the service robot can have a high-resolution front-facing camera and a small number of lower-resolution back-facing cameras. A front-facing camera operationally can take “up” images, corresponding to images taken while the camera is facing upwards towards the obstacle. The camera can take “down” images, corresponding to images taken while the camera is facing downwards towards the obstacle. The camera can take “middle” images, which are images taken while the camera is level with the floor. A service robot using a front-facing camera can recognize and categorize the objects in its environment if it is oriented so that the front-facing camera is directly aligned with the target object or set of objects.

The front-facing camera alignment with a target object can be achieved by rotating the service robot 104's body (e.g., by motor control of wheels of the service robot 104) to align the robot camera 108. The robot camera 108 itself may be moveable in multiple directions within or relative to the body of the service robot 104 to achieve or assist with its alignment with a target object or set of objects. For example, the robot camera 108 may be rotatably mounted within a socket or housing secured to the service robot 104's body and controlled by an electromechanical mechanism to rotate in multiple directions.

Examples of proprioceptive sensors include inertial sensors (e.g., tilt and acceleration), accelerometers, gyroscopes, magnetometers, compasses, wheel encoders, and temperature sensors. Inertial Measurement Units (IMUs) within a service robot 104 may include multiple accelerometers and gyroscopes, as well as magnetometers and barometers. Instantaneous pose (e.g., position and orientation) of the service robot 104, velocity (linear, angular), acceleration (linear, angular), and other parameters may be obtained through IMUs.

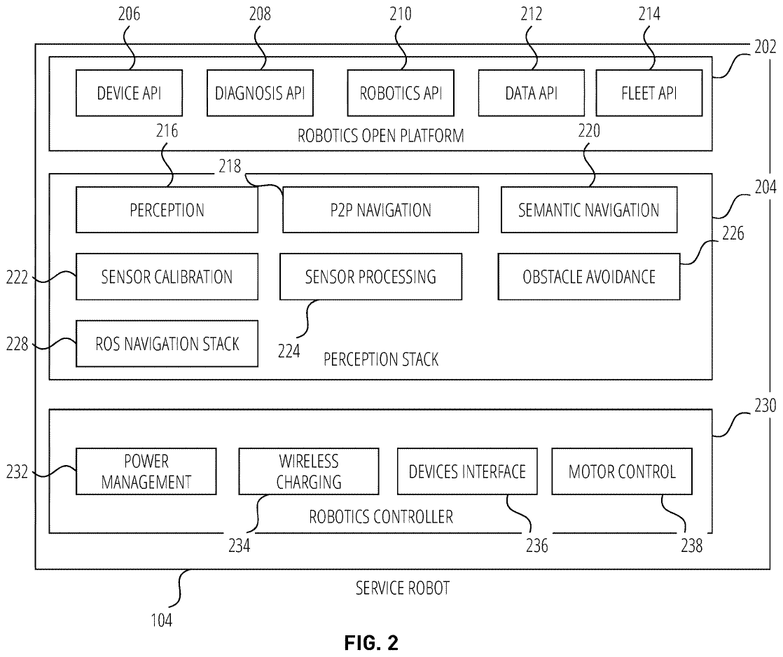

FIG. 2 is a block diagram illustrating one view of components and modules of a service robot 104, according to some examples. The service robot 104 includes a robotics open platform 202, a perception stack 204, and a robotics controller 230.

The robotics open platform 202 provides a number of Application Program Interfaces (APIs), including:
a device API 206
a diagnosis API 208
a robotics API 210
a data API 212; and
a fleet API 214

The perception stack 204 includes components that support:
perception 216
P2P navigation 218
semantic navigation 320
sensor calibration 222
sensor processing 224
obstacle avoidance 226.

A ROS navigation stack 228 also forms part of the perception stack 204.

The robotics controller 230 comprises components that support:
power management 232
wireless charging 234
devices interface 236
motor control 238.

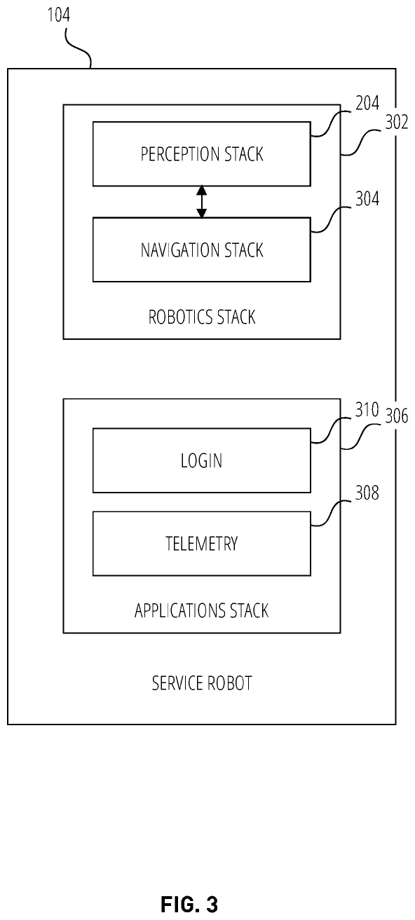

FIG. 3 is a block diagram illustrating another view of components and modules of a service robot 104, according to some examples. The service robot 104 includes a robotics stack 302 and an applications stack 306. The robotics stack 302, in turn, includes a navigation stack 304 and a perception stack 204. The applications stack 306 provides telemetry 308 and login 310 services for the service robot 104.

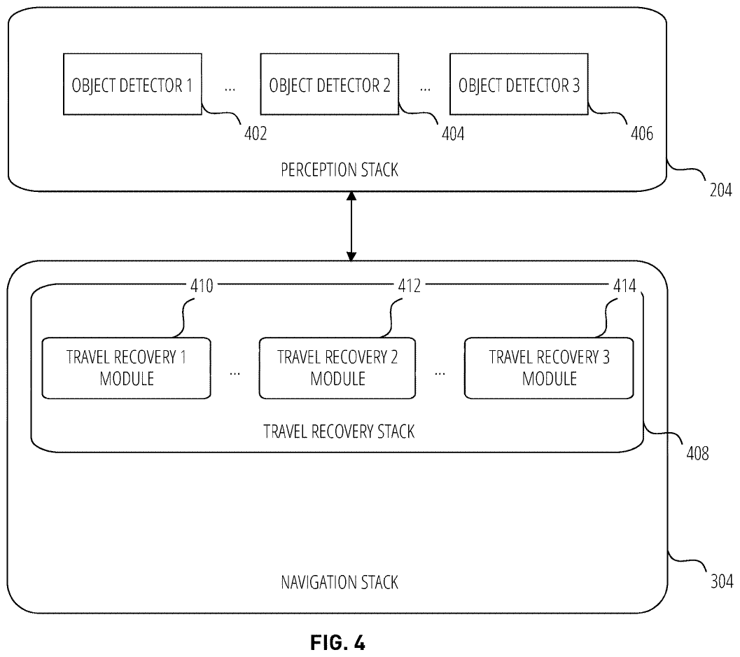

FIG. 4 is a block diagram illustrating yet another view of components and modules of a service robot 104, according to some examples. The perception stack 204 is shown to include object detector 402, object detector 404 and object detector 406. The navigation stack 304 is shown to include a travel recovery stack 408, which in turn includes example modules such as a travel recovery module 410, a travel recovery module 412, and a travel recovery module 414. In some examples, the navigation stack 304 may include a ROS navigation stack.

### ROBOT TRAVEL RECOVERY: EXAMPLE

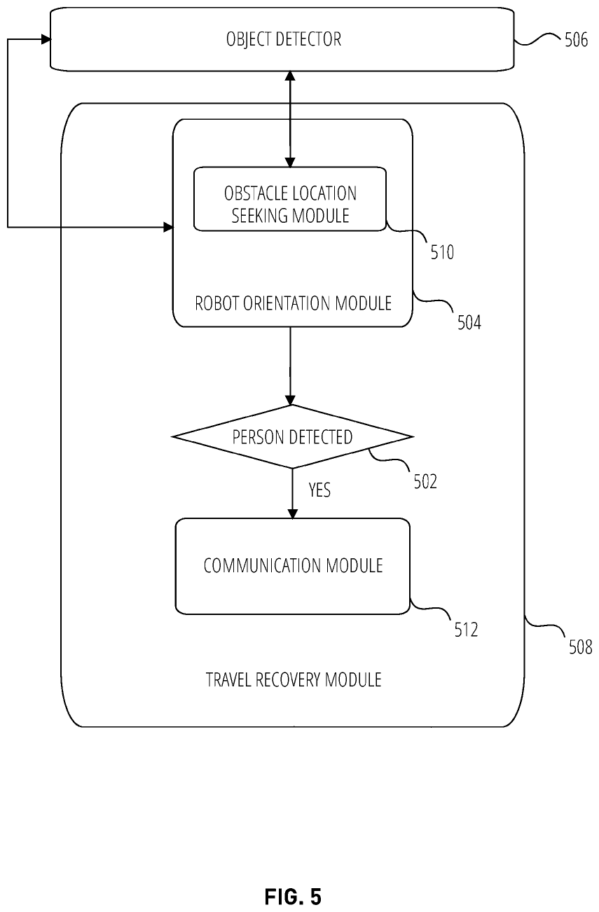

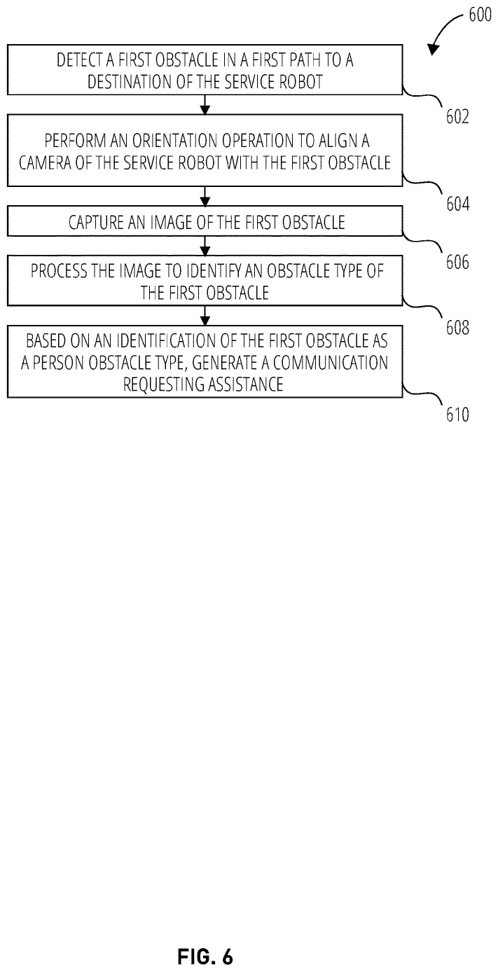

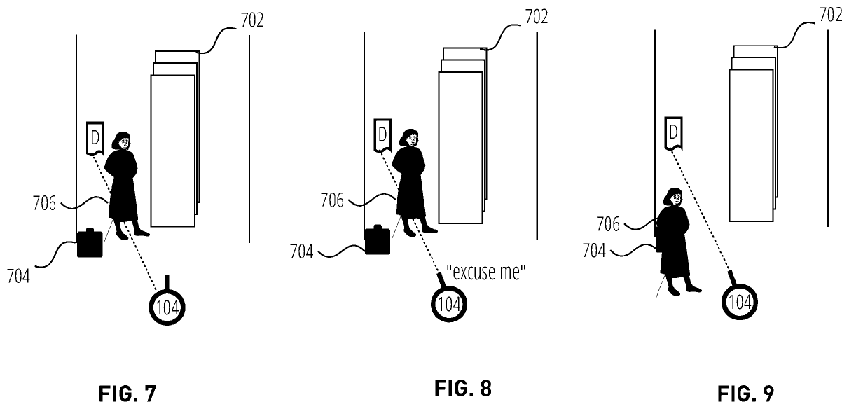

FIG. 5 is a block diagram illustrating another view of components and modules of a service robot 104 (see FIG. 6 for a related flowchart and FIG. 7, FIG. 8 and FIG. 9 for additional illustration purposes). The service robot 104 uses the object detector 506 (e.g., part of perception stack 204) to detect objects in a path towards the robot's destination. Upon detecting that it has become stuck, the service robot 104 uses a travel recovery module 508 (e.g., part of navigation stack 304) to recover a travel path to the destination.

A travel recovery module 508 includes the following modules:
a robot orientation module 504, which may include an obstacle location seeking module 510; and
a communication module 512.

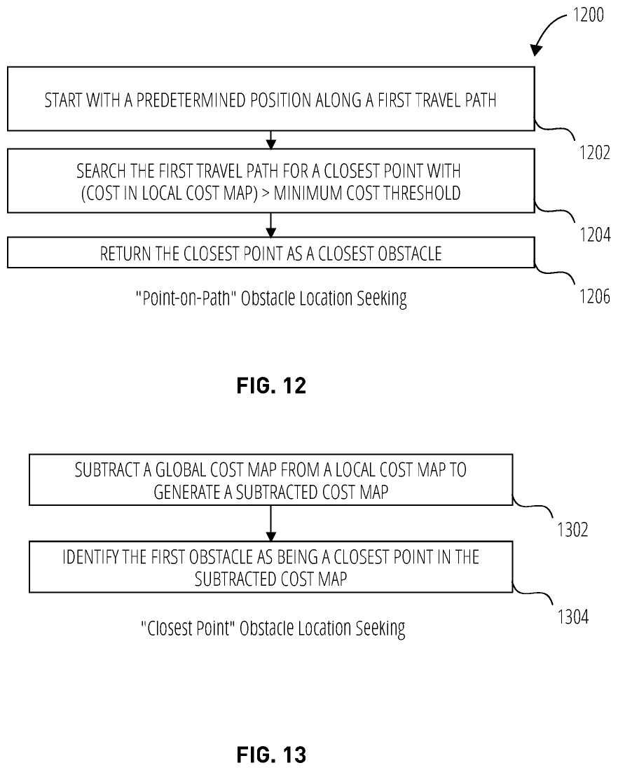

A travel recovery module 508 operates to perform travel recovery for the service robot 104, for example in situations in which travel of the service robot 104 from an origination point to a destination point is impeded or challenged. To this end, the travel recovery module 508 includes an obstacle location seeking module 510 to determine the location of an obstacle blocking the path of the service robot 104 (see FIG. 12 and FIG. 13 for example methods). The robot orientation module 504 orients a selected camera (e.g., a robot camera 108) of the service robot 104 towards the respective obstacle (or towards multiple obstacles). The robot camera can be a front-facing camera. The service robot 104 captures images of the respective obstacle (or multiple obstacles), which are processed by the object detector 506 in order to identify respective obstacle type(s). If a PERSON obstacle type is attributed to an obstacle (e.g., where the obstacle is identified as being a human) by the object detector 506, a communication module 512 generates an assistance-seeking communication (see at least FIG. 7, FIG. 8 and FIG. 9).

### OBJECT AND OBJECT-TYPE DETECTION

The service robot 104 uses the object detector 506 to detect objects on the particular and current travel path of the service robot 104. The object detector 506 can use vision sensors (e.g., two-dimensional (2D), three-dimensional (3D), depth and RGB cameras), light sensors, sound sensors (e.g., microphones or ultrasonic sensors), proximity sensors (e.g., infrared (IR) transceiver, ultrasound sensor, photoresistor), tactile sensors, temperature sensors, navigation and positioning sensors (e.g., Global Positioning System (GPS) sensor), visual odometry and visual-SLAM (simultaneous localization and mapping).

An object detector 506 processes images captured by the robot camera 108, for example a front-facing camera. For a service robot 104 using a front-facing camera with a limited field of view, the performance of object and object-type detection is improved by aligning the robot camera 108 to fully face a potential obstacle, and by positioning the robot camera 108 with respect to its distance from the potential obstacle. The object detector 506 better identifies objects and object types if the robot camera 108 is substantially aligned with a potential obstacle, rather than being partially aligned with it or facing in a direction away from the potential obstacle. Alignment may accordingly be to the extent required for the robot camera 108 to sufficiently face the potential obstacle in order for the robot camera 108 to capture an image of the potential obstacle of sufficient scope and clarity to enable use of the image for object recognition purposes.

Performance of the object detector 506 is enhanced when processing images captured by a robot camera 108 that is positioned not too far or too close from the obstacle (for example, at a minimum distance of 0.5 m and a maximum distance of 1.0 m). Captured images can be “up,” “front” or “down” images: “up” images may be useful for detecting PERSON-type obstacles, while “down” and “front” images may be useful for detecting other obstacle types.

The object detector 506 uses a pre-trained object recognition and object type identification model (e.g., a TensorFlow model such as one in TensorFlow 2 Detection Model Zoo, an OpenCV model, a Detectron2 model) to label objects in the processed images and identify their types. The object detector 506 runs the pre-trained model using CPU compute, processing the data locally, which can provide multiple advantages. First, local processing using CPU compute avoids potentially time-consuming data transfers to a server and allows for faster object detection and more robust obstacle avoidance, which is important in an example service environment with dynamic obstacles (e.g., a restaurant) or in a care environment with high-cost collisions (e.g., a hospital). Second, local processing using CPU compute allows the service robot 104 to function in the presence of network congestion (e.g., in a crowded conference or event center), or in the absence of network connectivity. Third, processing the data locally allows for increased privacy guarantees, which is important in a care environment (e.g., hospital) or in choice service environments (e.g., hotels).

The object detector 506 examines detected bounding boxes around detected objects with identified most likely object types. Each bounding box and respective identified object type are accompanied by a computed score, indicating how likely the detected object is to be of the respective type, according to the model used by the object detector 506.

The object detector 506 can use tunable thresholds to discard or isolate objects whose identified types have low scores (e.g., the object detector 506 is unsure of the object type).

The object detector 506 performs a depth estimate while processing camera images in order to determine if the path is actually blocked. The service robot 104 uses a depth camera and takes depth camera images, to be processed by the object detector 506.

According to some examples, an object detector 506 uses the dimensions of the identified bounding box for a detected obstacle to compute a distance indicator for the service robot and the potential obstacle. The distance indicator corresponds to an estimate of the distance between the service robot 104 and the potential obstacle. The distance indicator can be a binary value corresponding to whether or not the potential obstacle is close enough to the robot to block its path. Computing a distance indicator can use a depth estimate from a depth camera image. In some examples, computing the distance indicator uses a standard size for a respective object type. Computing a distance indicator can use a focal length measure for the robot camera. The computation of the distance indicator can be implemented as a rule, a set of rules, and/or using a machine-learned model.

### OBSTACLE-FACING ROBOT ORIENTATION

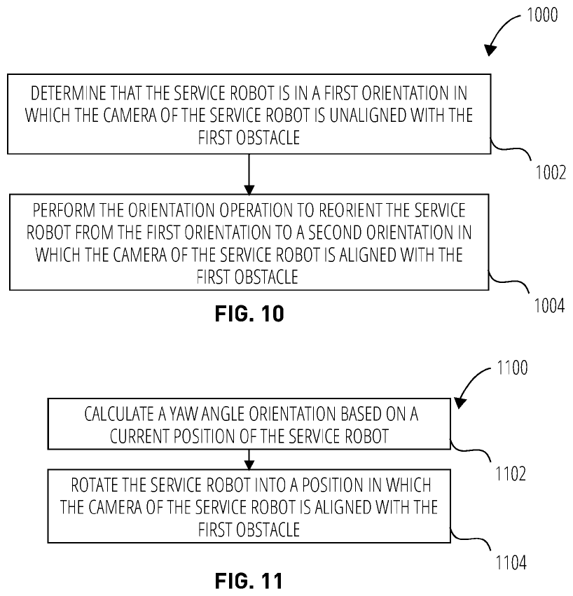

After detecting an object in a path to its destination, the service robot 104 uses the travel recovery module 508 to recover a travel path to the destination. The robot orientation module 504 orients the robot so that the robot camera 108 is aligned with an obstacle blocking a path to its destination, in order to capture better images of the obstacle and ensure a better performance of an image-based object and object-type detector. The robot orientation module 504 employs an obstacle location seeking module 510 to find the location of the main (e.g., closest) obstacle blocking its path. In some examples, the robot orientation module 504 orients the robot camera 108 based on the found location of the main (e.g., closest) blocking obstacle (or obstacles) service robot 104. In some examples, the module orients the robot camera 108 based on a current location of the service robot 104. FIG. 12 and FIG. 13 illustrate methods for obstacle location seeking, while FIG. 10 and FIG. 11 describe further operations of the robot orientation module 504.

### TRAVEL RECOVERY WITH ROBOT-PERSON COMMUNICATION

Once the camera of service robot 104 is aligned with a main obstacle (or multiple obstacles) in its path to the destination, the service robot 104 captures obstacle images, and the object detector 506 processes the images to determine their corresponding object types.

Upon the travel recovery module's detection of at least one PERSON-type obstacle, a communication module 512 seeks assistance. The assistance-related communication may be an audible communication generated at a speaker service of the service robot, and/or a visual communication (e.g., visual signaling, LED signaling, etc.).

An example communication is a request for an obstacle to be moved from the path of a service robot 104. The obstacle to be moved may be an inanimate object, such as a backpack, a bag, a purse, a laptop, a suitcase, a chair, a table, a cart, a trolley, a plant, a ladder and others. The obstacle to be moved may be another service robot, a person (e.g., a child) or an animal (a pet such as a dog, a cat, etc.).

The communication can be a request directed at the first obstacle (e.g., a person) that asks the first obstacle to move out of the service robot's path. For example, the communication can be directed at an obstacle of identified type PERSON. The communication can also involve an implicit request for the obstacle to move out of the service robot's path (e.g., the communication can state “Excuse me,” “May I please get through,” “Could you please let me through,” etc.). The communication can also explicitly request that an obstacle be moved from the robot's path (e.g., “Could you please help move/remove this <OBSTACLE>?,” “Could you please help with this <OBSTACLE>?,” where OBSTACLE corresponds to one of the obstacle types enumerated above.

FIG. 6 is a flowchart showing another view of a method 600, according to some examples, as performed by parts and components of the service robot as described in FIG. 5.

At operation 602, the object detector 506 detects a first obstacle in a first path to a destination of the service robot 104. At operation 604, the robot orientation module 504 performs an orientation operation to align a camera 108 of the service robot 104 with the first obstacle. At operation 606, the travel recovery module 508 captures an image of the first obstacle. At operation 608, the object detector 506 processes the image to identify an obstacle type of the first obstacle. At operation 610, based on an identification of the first obstacle as a PERSON obstacle type, the communication module 512 generates a communication requesting assistance.

FIG. 7, FIG. 8 and FIG. 9 are diagrammatic depictions of portions of an example travel recovery for a service robot 104. In this example, the robot detects an obstacle blocking its path to a destination point; upon the service robot 104 classifying the detected obstacle as a person and directing an “excuse me” communication to the person, the person unblocks the path and the robot is able to continue to the destination point. FIG. 7 depicts a portion of an example travel recovery for a service robot 104, showing a service robot 104 detect an obstacle blocking its travel path to destination point D. FIG. 8 depicts a portion of the example travel recovery, showing the result of the following operations: the camera 108 of service robot 104, initially not aligned with obstacle 706, is reoriented and aligned with obstacle 706; a captured image of obstacle 706 has been processed and the obstacle has been classified to have type PERSON; upon detecting a PERSON-type obstacle, the service robot 104 seeks assistance in the form an “excuse me” communication directed at the person blocking its path. FIG. 9 depicts a portion of the example travel recovery, showing an example outcome of a service robot's communication to a person: the person moved out of the way and the service robot is able to follow its path to destination point D.

FIG. 10 is a flowchart illustrating a method 1000 performed, according to some examples, by the robot orientation module 504. At operation 1002, the robot orientation module determines that the service robot is in a first orientation in which its camera is unaligned with the first obstacle. At operation 1004, the robot orientation module performs an orientation operation to reorient the service robot from a first to a second orientation, the second orientation being one in which the camera of the service robot is aligned with the first obstacle.

FIG. 11 is a flowchart illustrating a method 1100 performed, according to some examples, by the robot orientation module 504. At operation 1102, the robot orientation module calculates a yaw angle orientation based at least on a current position of the service robot. At operation 1104, the robot orientation module 504 rotates the service robot into a position in which the camera of the first robot is aligned with the first obstacle. According to some examples, computing the yaw angle orientation uses a location of the first obstacle. According to some examples, the operations in method 1100 are executed as part of the performing of the orientation operation in operation 1004.

### OBSTACLE LOCATION SEEKING: METHODS

FIG. 12 and FIG. 13 are flowcharts that illustrate obstacle location seeking methods used by an example obstacle location seeking module 510 in FIG. 5. FIG. 12 shows an example “Point-on-Path” method and FIG. 13 shows an example “Closest Point in the Subtracted Cost Map” method. In some examples, an obstacle location seeking module 510 uses a combination of these two methods. In some examples, the obstacle location seeking module 510 receives the location information (e.g., an example potential obstacle emits its coordinates). Both obstacle detection methods can use a global cost map, a current local cost map, and/or a global travel plan.

### Cost Maps

In some examples, a cost map is a grid-based map storing information about the obstacles in a given environment (e.g., the service environment). Each cell in the grid contains a cost value that indicates whether, and to which degree, a cell is occupied by an obstacle (and therefore cannot be traversed by a robot on an example path to a given destination). The value can be categorical, or a numerical score. Minimum cost thresholds can be applied to numerical cost values in order to ensure that noise in the construction of the cost map is filtered out, and that only salient obstacles or high-confidence obstacles are reflected by the cost map.

### Global Cost Maps

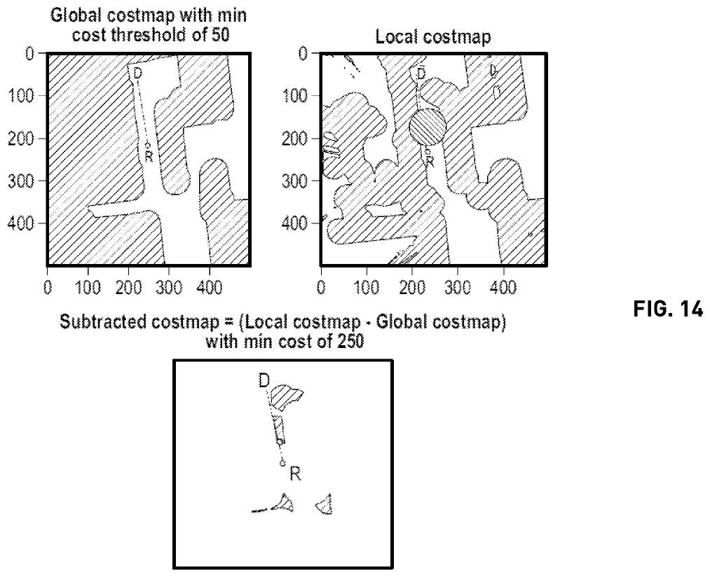

According to some examples, a global cost map (see FIG. 14 for an example) is a pre-computed cost map which stores information about the pre-existent static obstacles in an environment (e.g., walls, staircases, columns, fixture-type equipment). A global cost map for a given environment is pre-computed based at least on perception information about the environment and can be provided by a third party. A global cost map for a given environment can be pre-computed by starting with a given pre-computed cost map for an environment with a similar layout, and performing a series of operations to update it in order to accurately reflect the target environment.

### Local Cost Maps

According to some examples, a local cost map (see, e.g., FIG. 14) is a cost map dynamically computed at navigation time which reflects the obstacles in the service environment at that time. The example local cost map reflects the obstacles placed in a variable-size area around the robot.

The advantage of a local cost map is, according to some examples, it providing partial information about environment obstacle changes that have taken place after the global cost map was generated. For example, a local cost map can capture dynamic obstacles (e.g., people standing or moving, moved chairs or tables, accessories such as briefcases, suitcases, purses, movable equipment such as trolleys, carts, etc.)

### Subtracted Cost Maps

According to some examples, a subtracted cost map is a grid-based cost map where the subtracted cost value in a given cell is computed by subtracting the value in the corresponding cell in a global cost map from the value in the corresponding cell in a local cost map. The obstacle location seeking module 510 can compute a subtracted cost map in order to distinguish the dynamic obstacles (captured only by the local cost map) from the static obstacles (reflected by both the local cost maps and the global cost maps).

### Travel Path Planning

According to some examples, a global travel plan for the service robots 104 can be computed by a travel planner given a starting point, a destination, and a global map. According to some examples, a localized travel plan can be computed by a travel planner (e.g., teb_local_planner in a ROS navigation stack 228) given a starting point, a destination, a current local cost map and a global travel plan.

### POINT-ON-PATH OBSTACLE LOCATION SEEKING

FIG. 12 is a flowchart illustrating a “Point-on-Path” obstacle location seeking method, according to some examples.

At operation 1202, the obstacle location seeking module 510 for the service robot 104 starts operating at a predetermined position along a first travel path to the robot's destination. A first travel path can be a global travel plan computed by a global planner module of the navigation stack 304 based on a global cost map. The global travel plan can be computed by the ROS navigation stack (e.g., using one of the global planner classes of the ROS navigation library such as global planner, navfn, carot_planner). The global cost map and the global travel plan are provided by the travel recovery module 508 to the obstacle location seeking module 510. The obstacle location seeking module 510 has access to the current local cost map for the service robot 104.

At operation 1204, the obstacle location seeking module 510 searches the first travel path for the closest point from the predetermined start position such that the cost value in the corresponding grid cell of the local cost map is greater than a predetermined minimum cost threshold. In some examples, the obstacle location seeking module 510 seeks to identify small obstacles or noise by first applying a clustering operation, whose output is a set of point clusters. The obstacle location seeking module 510 can identify a set of “spurious” clusters based on an indicator, such as a predetermined minimum number of cluster points. The obstacle location seeking module 510 can identify a set of N most salient clusters, where Nis a tunable parameter. The number of points in each cluster is used as a salience indicator. In some examples, the obstacle location seeking module 510 searches for a point closest to predetermined start position such that the point is part of a non-spurious cluster and it is within a predetermined maximum distance from the first travel path. For example, the obstacle location seeking module 510 searches for a point closest to the predetermined start position such that the point is part of a top-N salient cluster and it is within a predetermined maximum distance from the first travel path. The predetermined start position can be a current position of the service robot. In some examples, the closest point is selected to be within a predetermined (e.g., min, max) distance range with respect to the predetermined start position. In some examples, the minimum distance is 0.5 m, and the maximum distance is 1.0 m.

At operation 1206, the obstacle location seeking module 510 returns the found closest point as a closest obstacle to the service robot 104.

### “CLOSEST POINT IN SUBTRACTED MAP” OBSTACLE SEEKING

FIG. 13 is a flowchart illustrating a “Closest Point in Subtracted Cost Map” obstacle location seeking method, according to some examples.

At operation 1302, the obstacle location seeking module 510 generates a subtracted cost map by subtracting each global cost map cost value from the corresponding local cost map cost value. At operation 1304, the obstacle location seeking module 510 finds the closest point to a current position of the service robot in the subtracted cost map and returns it as a closest obstacle to the service robot (see FIG. 14 for an example).

FIG. 14 shows an illustration, according to some examples, of the Closest Point in Subtracted Map method for obstacle location seeking. The three panels illustrate a global cost map (in this example, with a minimum cost value threshold of 50), a local cost map, and a respective subtracted cost map. The subtracted cost map is computed by subtracting each global cost map value in a from the corresponding local cost map value; in this example, a minimum cost value threshold value of 250 is also applied. The black dot marked “R” represents the service robot 104. “D” marks the robot's destination and the dotted line marks the robot's travel path. The large, patterned disc in the local cost map panel indicates the location of a “main” dynamic obstacle blocking the robot's travel path. As seen in the subtracted map panel and the corresponding small, patterned disc, the location of this obstacle is accurately recovered as the point closest to the robot in the subtracted map which has a cost value higher than a minimum cost threshold.

### ROBOT TRAVEL RECOVERY: ADDITIONAL EXAMPLES

### Travel Recovery with Multiple Blocked Paths

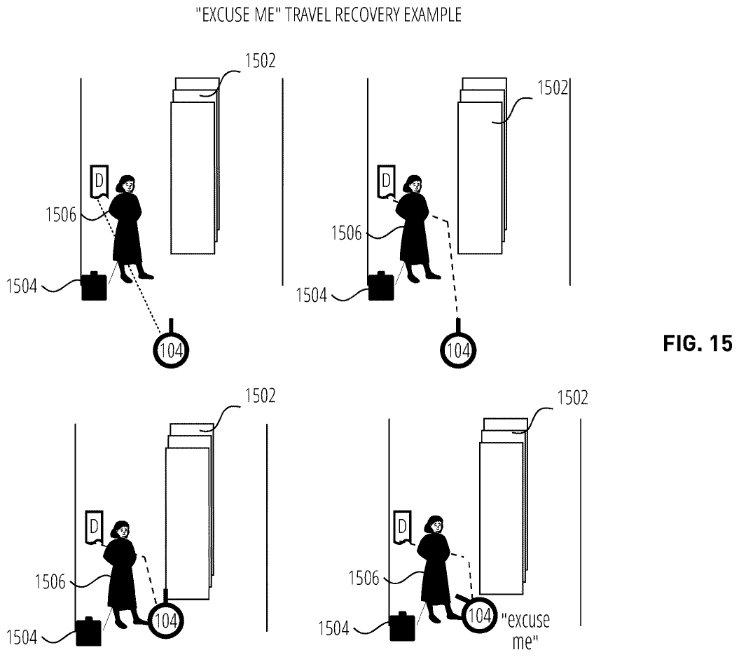

FIG. 15 shows an illustration of an additional behavior of the travel recovery module 508, according to some examples. In the top-left panel, a service robot 104 detects a first obstacle 1506 in a first path towards its destination “D”. Responsive to detection of this first obstacle, the travel recovery module 508 initiates a second travel path to the destination (see top-right panel). The service robot 104 subsequently detects a second obstacle 1502 on its second travel path to its destination (see bottom-left panel). For example, a service robot 104 can follow a second path around a detected obstacle, only to attempt traversing through a narrow space and encounter another obstacle (e.g., a static object such as a wall or a door). Responsive to detecting the second obstacle, the robot's travel recovery module 508 uses its obstacle location seeking module 510 to find the location of first obstacle 1506; the travel recovery module 508 then uses its robot orientation module to orient the robot's camera such that it is aligned with first obstacle 1506 (see bottom-right panel). The service robot 104 then captures an image of first obstacle 1506 and responsive to its object detector identifying the first obstacle as a PERSON-type obstacle, the travel recovery module uses its communication module to generate a communication requesting assistance (e.g., communicating an “excuse me”, “may I please get by”, etc. message to the person). In some examples, the travel recovery module 508 uses its communication module to generate a communication requesting assistance upon the object detector identifying the first obstacle as another service robot.

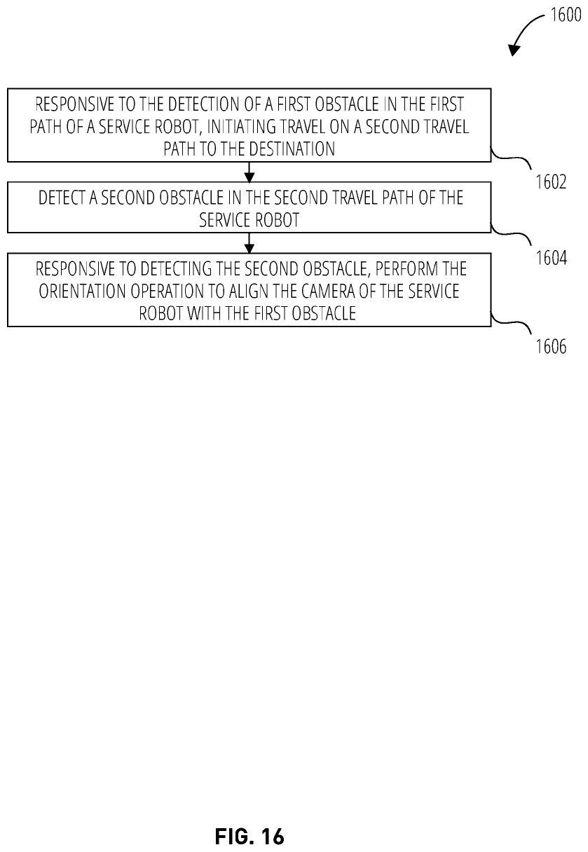

FIG. 16 is a flowchart illustrating a method 1600, according to some examples, such as the one in FIG. 15. At operation 1602, responsive to the detection of a first obstacle in the first path of a service robot 104, the service robot 104 initiates travel on a second travel path to the destination. At operation 1604, the service robot 104 detects a second obstacle in the second travel path of the service robot 104. At operation 1606, responsive to detecting the second obstacle, the service robot 104 performs an orientation operation to align its camera with the first obstacle.

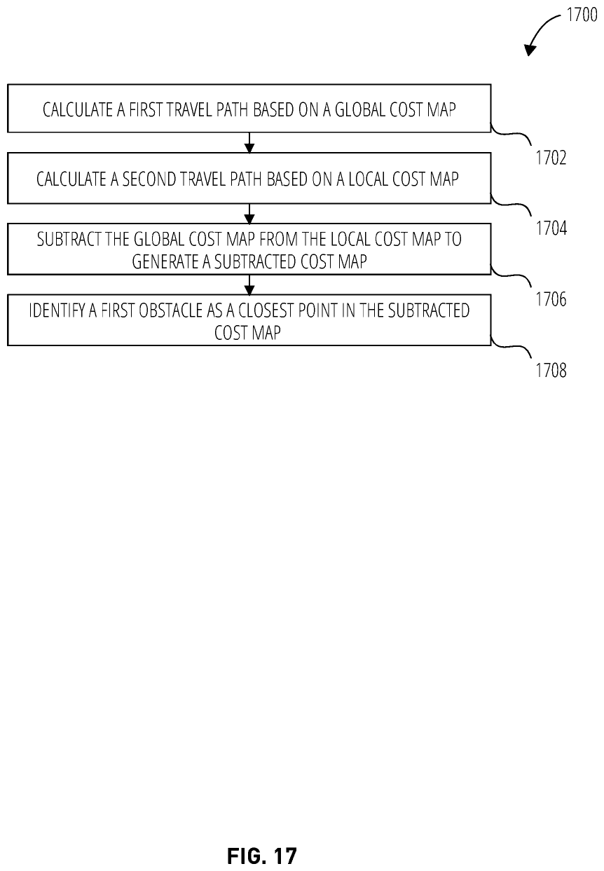

FIG. 17 is a flowchart illustrating a further method 1700 related to some examples, such as the one in FIG. 15. At operation 1702, a first travel path is calculated based on a global cost map. At operation 1704, a second travel path is calculated based on a local cost map. At operation 1706, a subtracted cost map is calculated by subtracting the global cost map from the lowest cost map. At operation 1708, a first obstacle is identified as a closest point in the subtracted cost map.

### Travel Recovery with Multiple Obstacles Per Path

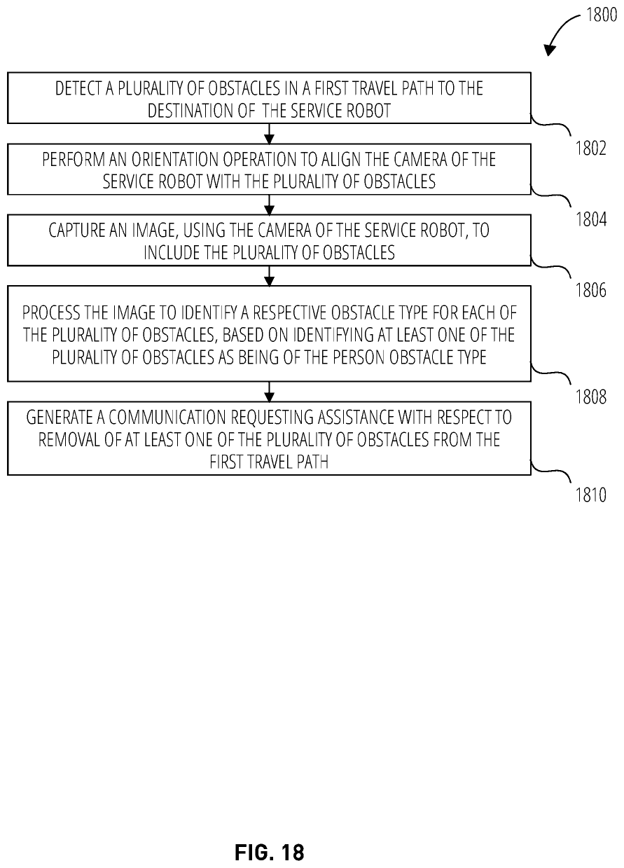

FIG. 18 is a flowchart illustrating an additional method 1800 implemented by a travel recovery module, according to some examples. At operation 1802, the travel recovery module of the service robot 104 can operationally detect multiple obstacles in a first travel path to the destination of the service robot. An orientation operation to align the camera of the service robot with the multiple obstacles is performed at operation 1804.

The method includes capturing an image, using the camera of the service robot, to include the multiple obstacles at operation 1806. The method includes processing of the image to identify a respective obstacle type for each of the plurality of obstacles, based on the identification of at least one of the multiple obstacles as being of the PERSON obstacle type at operation 1808.

At operation 1810, the service robot generates a communication requesting assistance with respect to removal of at least one of the multiple obstacles from the first travel path. The obstacle to be moved can be an inanimate object, such as a backpack, a bag, a purse, a laptop, a suitcase, a chair, a table, a cart, a trolley, a plant, a ladder and others. The obstacle to be moved can be another service robot. The obstacle to be moved can be a person (e.g., a child) or an animal (a pet such as a dog, a cat, etc.). The communication is a request directed at an obstacle that asks the obstacle to move out of the service robot's path. The communication is directed at an obstacle of identified type PERSON.

The communication can involve an implicit request for an obstacle to move out of the service robot's path (e.g., the communication can state “Excuse me,” “May I please get through,” “Could you please let me through,” etc.). The communication can explicitly request that an obstacle be moved from the robot's path (e.g., “Could you please help move/remove this <OBSTACLE>?,” “Could you please help with this <OBSTACLE>?,” where OBSTACLE corresponds to one of the obstacle types enumerated above.

### Additional Travel Recovery Examples

In some examples, a service robot 104 uses multiple travel recovery modules. In some examples, different travel recovery modules can be used in a serial (sequential) fashion. In some examples, the travel recovery behaviors can be nested.

In some examples, the service robot 104 uses a “clearing the cost map” recovery module (not shown) or behavior (e.g., a “clear_costmap_recovery” behavior in the ROS navigation stack 228). This module can help when dynamic obstacles mistakenly persist in the local cost map after the service robot has passed by them. The clearing of the local cost map can include replacing values of the cells in the robot's local cost map with the values of the corresponding cells in a pre-computed global cost map. In some examples, the cells whose values are replaced are located outside a square with sides of a predetermined length and which is centered on the position of the service robot.

In some examples, the service robot 104 uses a “panning recovery” module (not shown) or behavior. One goal of the panning recovery behavior is to check that the robot is in fact blocked from following a path to its destination: a local cost map could be noisy and the robot can try to avoid an obstacle that is not there, or that it is not blocking the path. In some examples, the service robot 104 first uses a “clearing the cost map” recovery module to clear its local cost map. In some examples, the “panning recovery” behavior includes the service robot turning to its left and/or right. In some examples, the behavior includes recomputing or acquiring a subset of the cell values in the current local cost map in order to reflect current potential obstacles. In some examples, the service robot checks that the path to the destination, given its local cost map, is indeed blocked.

### SERVICE ROBOT: OVERVIEW

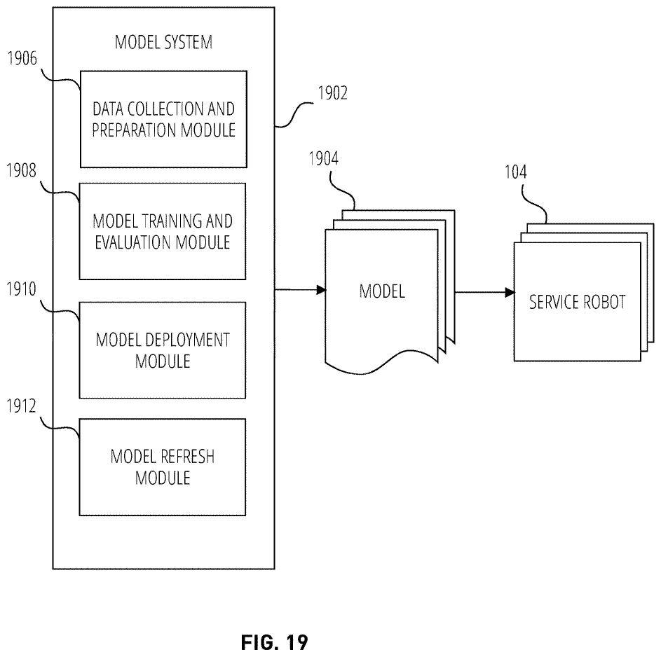

FIG. 19 is a block diagram showing a model system 1902, according to some examples, that operates to create and maintain image localization models 1904 that are deployed at various service robots 104 at one or more locations 2302. The model system 1902 includes the following components or modules:
Data collection and preparation module 1906;
Model training and evaluation module 1908;
Model deployment module 1910; and
Model refresh module 1912.

Further details regarding the operations of these example modules are provided below.

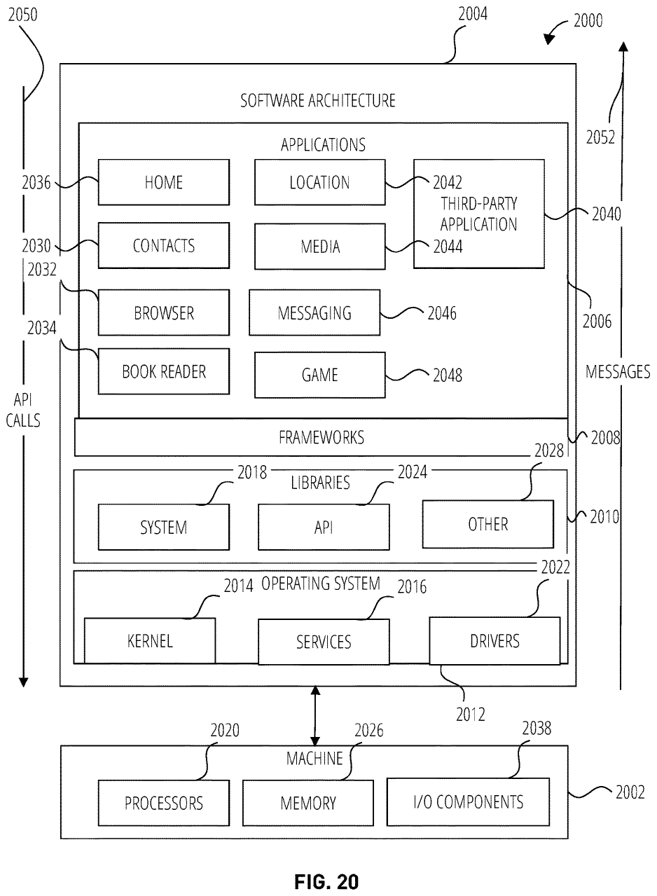

FIG. 20 is a block diagram 2000 illustrating a software architecture 2004, which can be installed on any one or more of the devices described herein. The software architecture 2004 is supported by hardware such as a machine 2002 that includes processors 2020, memory 2026, and I/O components 2038. In this example, the software architecture 2004 can be conceptualized as a stack of layers, where each layer provides a particular functionality. The software architecture 2004 includes layers such as an operating system 2012, libraries 2010, frameworks 2008, and applications 2006. Operationally, the applications 2006 invoke API calls 2050 through the software stack and receive messages 2052 in response to the API calls 2050.

The operating system 2012 manages hardware resources and provides common services. The operating system 2012 includes, for example, a kernel 2014, services 2016, and drivers 2022. The kernel 2014 acts as an abstraction layer between the hardware and the other software layers. For example, the kernel 2014 provides memory management, Processor management (e.g., scheduling), component management, networking, and security settings, among other functionalities. The services 2016 can provide other common services for the other software layers. The drivers 2022 are responsible for controlling or interfacing with the underlying hardware. For instance, the drivers 2022 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, and power management drivers.

The libraries 2010 provide a low-level common infrastructure used by the applications 2006. The libraries 2010 can include system libraries 2018 (e.g., C standard library) that provide functions such as memory allocation functions, string manipulation functions, mathematic functions, and the like. In addition, the libraries 2010 can include API libraries 2024 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., Web Kit to provide web browsing functionality), and the like. The libraries 2010 can also include a wide variety of other libraries 2028 to provide many other APIs to the applications 2006.

The frameworks 2008 provide a high-level common infrastructure used by the applications 2006. For example, the frameworks 2008 provide various graphical user interface (GUI) functions, high-level resource management, and high-level location services. The frameworks 2008 can provide a broad spectrum of other APIs that can be used by the applications 2006, some of which may be specific to a particular operating system or platform.

The applications 2006 may include a home application 2036, a contacts application 2030, a browser application 2032, a book reader application 2034, a location application 2042, a media application 2044, a messaging application 2046, a game application 2048, and a broad assortment of other applications such as a third-party application 2040. Applications 1406 are programs that execute functions defined in the programs. Various programming languages can be employed to create one or more of the applications 2006, structured in a variety of manners, such as object-oriented programming languages (e.g., Objective-C, Java, or C++) or procedural programming languages (e.g., C or assembly language). In a specific example, the third-party application 2040 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 2040 can invoke the API calls 2050 provided by the operating system 2012 to facilitate functionality described herein.

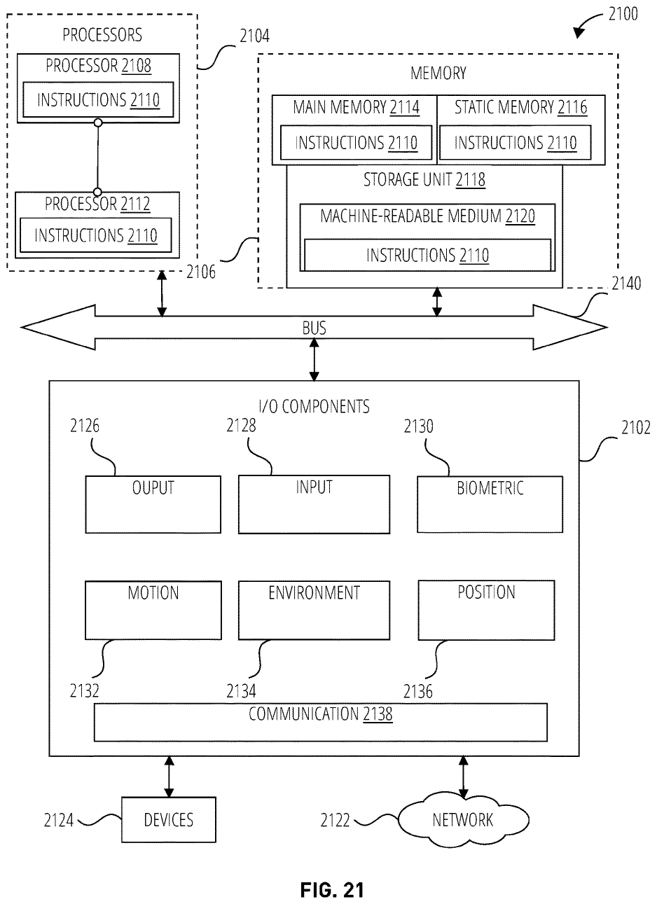

FIG. 21 is a diagrammatic representation of the machine 2100 within which instructions 2110 (e.g., software, a program, an application, an applet, an app, or other executable code) for causing the machine 2100 to perform any one or more of the methodologies discussed herein may be executed. For example, the instructions 2110 may cause the machine 2100 to execute any one or more of the methods described herein. The instructions 2110 transform the general, non-programmed machine 2100 into a particular machine 2100 programmed to carry out the described and illustrated functions in the manner described. The machine 2100 may operate as a standalone device or be coupled (e.g., networked) to other machines. In a networked deployment, the machine 2100 may operate in the capacity of a server machine or a client machine in a server-client network environment, or as a peer machine in a peer-to-peer (or distributed) network environment. The machine 2100 may comprise, but not be limited to, a server computer, a client computer, a personal computer (PC), a tablet computer, a laptop computer, a netbook, a set-top box (STB), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 2110, sequentially or otherwise, that specify actions to be taken by the machine 2100. Further, while a single machine 2100 is illustrated, the term “machine” may include a collection of machines that individually or jointly execute the instructions 2110 to perform any one or more of the methodologies discussed herein.

The machine 2100 may include processors 2104, memory 2106, and I/O components 2102, which may be configured to communicate via a bus 2140. In some examples, the processors 2104 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application-Specific Integrated Circuit (ASIC), a Radio-Frequency Integrated Circuit (RFIC), another Processor, or any suitable combination thereof) may include, for example, a Processor 2108 and a Processor 2112 that execute the instructions 2110. The term “Processor” is intended to include multi-core processors that may comprise two or more independent processors (sometimes referred to as “cores”) that may execute instructions contemporaneously. Although FIG. 21 shows multiple processors 2104, the machine 2100 may include a single processor with a single core, a single processor with multiple cores (e.g., a multi-core processor), multiple processors with a single core, multiple processors with multiples cores, or any combination thereof.

The memory 2106 includes a main memory 2114, a static memory 2116, and a storage unit 2118, both accessible to the processors 2104 via the bus 2140. The main memory 2106, the static memory 2116, and storage unit 2118 store the instructions 2110 embodying any one or more of the methodologies or functions described herein. The instructions 2110 may also reside, wholly or partially, within the main memory 2114, within the static memory 2116, within machine-readable medium 2120 within the storage unit 2118, within the processors 2104 (e.g., within the processor's cache memory), or any suitable combination thereof, during execution thereof by the machine 2100.

The I/O components 2102 may include various components to receive input, provide output, produce output, transmit information, exchange information, or capture measurements. The specific I/O components 2102 included in a particular machine depend on the type of machine. For example, portable machines such as mobile phones may include a touch input device or other such input mechanisms, while a headless server machine will likely not include such a touch input device. The I/O components 2102 may include many other components not shown in FIG. 21. In various examples, the I/O components 2102 may include output components 2126 and input components 2128. The output components 2126 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), or other signal generators. The input components 2128 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 2102 may include biometric components 2130, motion components 2132, environmental components 2134, or position components 2136, among a wide array of other components. For example, the biometric components 2130 include components to detect expressions (e.g., hand expressions, facial expressions, vocal expressions, body gestures, or eye-tracking), measure biosignals (e.g., blood pressure, heart rate, body temperature, perspiration, or brain waves), or identify a person (e.g., voice identification, retinal identification, facial identification, fingerprint identification, or electroencephalogram-based identification). The motion components 2132 include acceleration sensor components (e.g., accelerometer), gravitation sensor components, rotation sensor components (e.g., gyroscope). The environmental components 2134 include, for example, one or cameras, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 2136 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 2102 further include communication components 2138 operable to couple the machine 2100 to a network 2122 or devices 2124 via respective coupling or connections. For example, the communication components 2138 may include a network interface Component or another suitable device to interface with the network 2122. In further examples, the communication components 2138 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 2124 may be another machine or any of a wide variety of peripheral devices (e.g., a peripheral device coupled via a USB).

Moreover, the communication components 2138 may detect identifiers or include components operable to detect identifiers. For example, the communication components 2138 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Data glyph, Maxi Code, PDF417, Ultra Code, UCC RSS-2D bar code, and other optical codes), or acoustic detection components (e.g., microphones to identify tagged audio signals). In addition, a variety of information may be derived via the communication components 2138, such as location via Internet Protocol (IP) geolocation, location via Wi-Fi® signal triangulation, or location via detecting an NFC beacon signal that may indicate a particular location.

The various memories (e.g., main memory 2114, static memory 2116, and/or memory of the processors 2104) and/or storage unit 2118 may store one or more sets of instructions and data structures (e.g., software) embodying or used by any one or more of the methodologies or functions described herein. These instructions (e.g., the instructions 2110), when executed by processors 2104, cause various operations to implement the disclosed examples.

The instructions 2110 may be transmitted or received over the network 2122, using a transmission medium, via a network interface device (e.g., a network interface component included in the communication components 2138) and using any one of several well-known transfer protocols (e.g., hypertext transfer protocol (HTTP)). Similarly, the instructions 2110 may be transmitted or received using a transmission medium via a coupling (e.g., a peer-to-peer coupling) to the devices 2124.

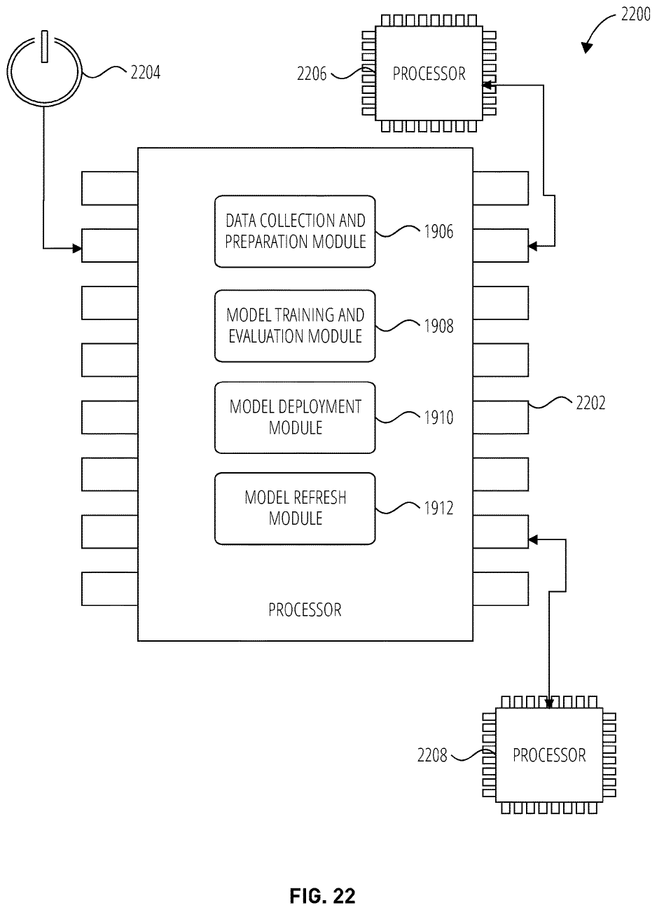

Turning now to FIG. 22, a diagrammatic representation of a processing environment 2200 is shown, which includes a processor 2202, a processor 2206 and a processor 2208 (e.g., a GPU, CPU, or combination thereof).

The processor processors 2202 is shown to be coupled to a power source 2204, and to include (either permanently configured or temporarily instantiated) modules, namely a data collection and preparation module 1906, a model training and evaluation module 1908, a model deployment module 1910 and a model refresh module 1912.

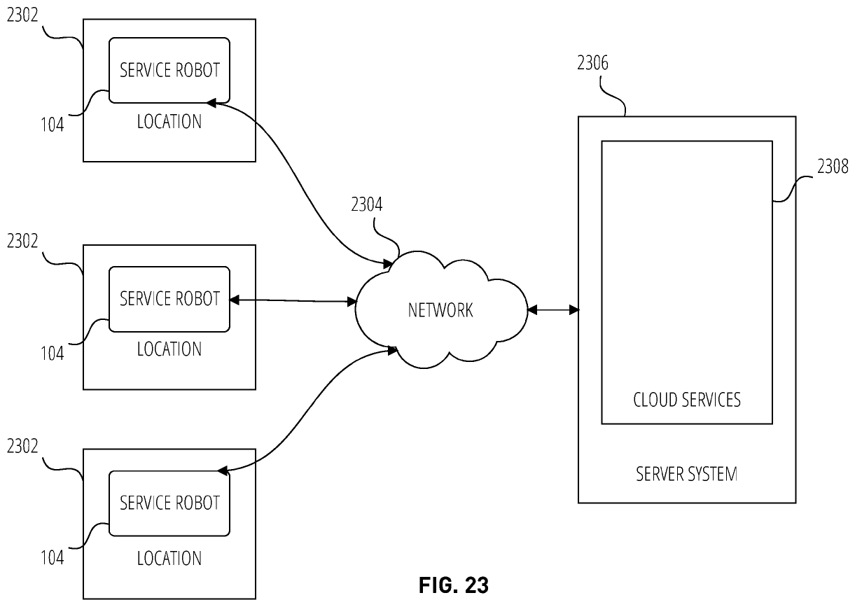

FIG. 23 is a diagrammatic representation of an environment in which multiple service robots 104 (e.g., a fleet of service robots) are deployed to respective locations 2302 or environments, such as restaurants, hospitals, or senior care facilities. Depending on the location, the service robots 104 may perform any one of a number of functions within the location 2302. Taking the example where these locations 2302 are service locations such as restaurants, the service robots 104 may operate to assist with the delivery of items from a kitchen to tables within a particular restaurant, as well as the transportation of plates, trash, etc., from tables back to the kitchen.

Each of the service robots 104 is communicatively coupled by a network 2304, or multiple networks 2304, to cloud services 2308, which reside at one or more server systems 2306.

### EXAMPLES

Example 1 is a computer-implemented method to recover travel of a service robot, the method comprising: detecting a first obstacle in a first travel path to a destination of the service robot; performing an orientation operation to align a camera of the service robot with the first obstacle; capturing an image of the first obstacle; processing the image to identify an obstacle type of the first obstacle; and based on an identification of the first obstacle as a person obstacle type, generating a communication requesting assistance.

In Example 2, the subject matter of Example 1 includes the communication being a request for the first obstacle to be removed from the first travel path.

In Example 3, the subject matter of Example 2 includes the communication being a request directed at the first obstacle that asks the first obstacle to move out of the first travel path.

In Example 4, the subject matter of Examples 2-3 includes the communication being an audible communication generated at a speaker system of the service robot.

In Example 5, the subject matter of Examples 1-4 includes: determining that the service robot is in a first orientation in which the camera of the service robot is unaligned with the first obstacle, and performing the orientation operation responsive to the determination that the service robot is in the first orientation, the orientation operation to reorient the service robot from the first orientation to a second orientation in which the camera of the service robot is aligned with the first obstacle.

In Example 6, the subject matter of Examples 1-5 includes, wherein the performing of the orientation operation comprises: calculating a yaw angle orientation based on a current position of the service robot; and rotating the service robot into a position in which the camera of the service robot is aligned with the first obstacle.

In Example 7, the subject matter of Examples 1-6 includes, responsive to the detection of the first obstacle in the first travel path of the service robot, initiating travel on a second travel path to the destination; detecting a second obstacle in the second travel path of the service robot; and responsive to detecting the second obstacle, performing the orientation operation to align the camera of the service robot with the first obstacle.

In Example 8, the subject matter of Example 7 includes, wherein: the first travel path is calculated using a global cost map and the second travel path is calculated using a local cost map; and the performing of the orientation operation further comprises: subtracting the global cost map from the local cost map to generate a subtracted cost map; and identifying the first obstacle as being a closest point in the subtracted cost map.

In Example 9, the subject matter of Examples 1-8 includes, wherein the processing of the image is performed using CPU compute.

In Example 10, the subject matter of Examples 1-9 includes, wherein the processing of the image comprises performing a depth estimate to identify the first obstacle as a person.

In Example 11, the subject matter of Examples 1-10 includes, wherein the detecting of the first obstacle is performed using a LiDAR of the service robot.

In Example 12, the subject matter of Examples 1 -11 includes, wherein the method further comprises: detecting a plurality of obstacles in the first travel path to the destination of the service robot; performing the orientation operation to align the camera of the service robot with the plurality of obstacles; capturing the image, using the camera of the service robot, to include the plurality of obstacles; processing of the image to identify a respective obstacle type for each of the plurality of obstacles, based on the identification of at least one of the plurality of obstacles as being of the person obstacle type; and generating a communication requesting assistance with respect to removal of at least one of the plurality of obstacles from the first travel path.

In Example 13, the subject matter of Examples 5-12 includes, wherein performing the orientation operation further comprises subtracting a global cost map from a local cost map to generate a subtracted cost map.

In Example 14, the subject matter of Example 13 includes, identifying the first obstacle as being a closest point in the subtracted cost map.

In Example 15, the subject matter of Examples 5-14 includes, wherein the performing of the orientation operation further comprises identifying the first obstacle as a closest obstacle according to the first travel path.

In Example 16, the subject matter of Example 15 includes, wherein the identifying of the closest obstacle according to the first travel path further comprises: starting with a predetermined position along the first travel path, searching the first travel path for a closest point with a respective cost in a local cost map being greater than a predetermined minimum cost threshold; and returning the closest point as the closest obstacle.

In Example 17, the subject matter of Example 16 includes, wherein the predetermined position along the first travel path is a current position of the service robot.

In Example 18, the subject matter of Examples 16-17 includes, wherein the closest point along the first travel path is further selected to be within a predetermined distance range from the predetermined position.

Example 19 is at least one machine-readable medium including instructions that, when executed by processing circuitry, cause the processing circuitry to perform operations to implement of any of Examples 1-18.

Example 20 is an apparatus comprising means to implement any of Examples 1-18.

Example 21 is a system to implement any of Examples 1-18.

### GLOSSARY

“Carrier Signal” refers to any intangible medium capable of storing, encoding, or carrying instructions for execution by the machine, and includes digital or analog communications signals or other intangible media to facilitate communication of such instructions. Instructions may be transmitted or received over a network using a transmission medium via a network interface device.

“Communication Network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other processing the data entirely locally, which has multiple advantages. First, it avoids potentially time-consuming data transfers to a server and allows for faster object detection and more robust obstacle avoidance, which is important in an example service environment with dynamic obstacles (e.g., a restaurant) or in a care environment with high-cost collisions (e.g., a hospital). Second, using CPU compute allows the service robot to function in the presence of network congestion (e.g., in a crowded conference or event center), or in the absence of network connectivity. Third, processing the data locally allows for increased privacy guarantees, which is important in a care environment (e.g., hospital) or in choice service environments (e.g. hotels). components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner In examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) tailored to perform the configured functions and are no longer general-purpose processors. A decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), the hardware components need not be configured or instantiated at any one instance in time. For example, where a hardware component comprises a general-purpose processor configured by software to become a special-purpose processor, the general-purpose processor may be configured as different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of methods described herein may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm).

In some examples, the processors or processor-implemented components may be distributed across a number of geographic locations.

“Computer-Readable Medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine-Storage Medium” refers to a single or multiple storage devices and/or media (e.g., a centralized or distributed database, and/or associated caches and servers) that store executable instructions, routines and/or data. The term includes solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks, The terms “machine-storage medium”, “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, some of which are covered under the term “signal medium.”

“Module” refers to logic having boundaries defined by function or subroutine calls, branch points, Application Program Interfaces (APIs), or other technologies that provide for the partitioning or modularization of particular processing or control functions. Modules are typically combined via their interfaces with other modules to carry out a machine process. A module may be a packaged functional hardware unit designed for use with other components and a part of a program that usually performs a particular function of related functions. Modules may constitute either software modules (e.g., code embodied on a machine-readable medium) or hardware modules. A “hardware module” is a tangible unit capable of performing certain operations and may be configured or arranged in a certain physical manner. In various examples, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein. In some examples, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations. Accordingly, the phrase “hardware module” (or “hardware-implemented module”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time. Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In examples in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information). The various operations of example methods and routines described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors. Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some examples, the processors or processor-implemented modules may be located in a single geographic location (e.g., within a home environment, an office environment, or a server farm). In other examples, the processors or processor-implemented modules may be distributed across a number of geographic locations.

“Processor” refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“Signal Medium” refers to any intangible medium that is capable of storing, encoding, or carrying the instructions for execution by a machine and includes digital or analog communications signals or other intangible media to facilitate communication of software or data. The term “signal medium” may o include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

What is claimed is:

1. A computer-implemented method to recover travel of a service robot, the method comprising:
detecting a first obstacle in a first travel path to a destination of the service robot;
performing an orientation operation to align a camera of the service robot with the first obstacle;
capturing an image of the first obstacle;
processing the image to identify an obstacle type of the first obstacle; and
based on an identification of the first obstacle as a person obstacle type, generating a communication requesting assistance.

2. The method of claim 1, wherein the communication is a request for the first obstacle to be removed from the first travel path.

3. The method of claim 2, wherein the communication is a request directed at the first obstacle that asks the first obstacle to move out of the first travel path.

4. The method of claim 2, wherein the communication is an audible communication generated at a speaker system of the service robot.

5. The method of claim 1, further comprising:
determining that the service robot is in a first orientation in which the camera of the service robot is unaligned with the first obstacle, and
performing the orientation operation responsive to the determination that the service robot is in the first orientation, the orientation operation to reorient the service robot from the first orientation to a second orientation in which the camera of the service robot is aligned with the first obstacle.

6. The method of claim 1, wherein the performing of the orientation operation comprises: calculating a yaw angle orientation based on a current position of the service robot; and rotating the service robot into a position in which the camera of the service robot is aligned with the first obstacle.

7. The method of claim 1, further comprising:
responsive to the detection of the first obstacle in the first travel path of the service robot, initiating travel on a second travel path to the destination;
detecting a second obstacle in the second travel path of the service robot; and
responsive to detecting the second obstacle, performing the orientation operation to align the camera of the service robot with the first obstacle.

8. The method of claim 7, wherein:
the first travel path is calculated using a global cost map and the second travel path is calculated using a local cost map; and
the performing of the orientation operation further comprises:
subtracting the global cost map from the local cost map to generate a subtracted
cost map; and
identifying the first obstacle as being a closest point in the subtracted cost map.

9. The method of claim 1, wherein the processing of the image is performed using CPU compute.

10. The method of claim 1, wherein the processing of the image comprises performing a depth estimate to identify the first obstacle as a person.

11. The method of claim 1, wherein the detecting of the first obstacle is performed using a LiDAR of the service robot.

12. The method of claim 1, further comprising:
detecting a plurality of obstacles in the first travel path to the destination of the service robot;
performing the orientation operation to align the camera of the service robot with the plurality of obstacles;
capturing the image, using the camera of the service robot, to include the plurality of obstacles;
processing the image to identify a respective obstacle type for each of the plurality of obstacles, based on the identification of at least one of the plurality of obstacles as being of the person obstacle type; and
generating a communication requesting assistance with respect to removal of at least one of the plurality of obstacles from the first travel path.

13. The method of claim 5, wherein performing the orientation operation further comprises subtracting a global cost map from a local cost map to generate a subtracted cost map.

14. The method of claim 13, further comprising identifying the first obstacle as being a closest point in the subtracted cost map.

15. The method of claim 5, wherein the performing of the orientation operation further comprises identifying the first obstacle as a closest obstacle according to the first travel path.

16. The method of claim 15, wherein the identifying of the closest obstacle according to the first travel path further comprises:
starting with a predetermined position along the first travel path, searching the first travel path for a closest point with a respective cost in a local cost map being greater than a predetermined minimum cost threshold; and
returning the closest point as the closest obstacle.

17. The method of claim 16, wherein the predetermined position along the first travel path is a current position of the service robot.

18. The method of claim 16, wherein the closest point along the first travel path is further selected to be within a predetermined distance range from the predetermined position.

19. A computing apparatus comprising:
a processor; and
a memory storing instructions that, when executed by the processor, configure the apparatus to:
detect a first obstacle in a first travel path to a destination of a service robot;
perform an orientation operation to align a camera of the service robot with the first obstacle;
capture an image of the first obstacle;
process the image to identify an obstacle type of the first obstacle; and
based on an identification of the first obstacle as a person obstacle type, generate a communication requesting assistance.

20. A non-transitory computer-readable storage medium, the computer-readable storage medium including instructions that when executed by a computer, cause the computer to:
detect a first obstacle in a first travel path to a destination of a service robot;
perform an orientation operation to align a camera of the service robot with the first obstacle;
capture an image of the first obstacle;
process the image to identify an obstacle type of the first obstacle; and
based on an identification of the first obstacle as a person obstacle type, generate a communication requesting assistance.
